(19) United States
(12) Patent Application Publication
(10) Pub. No.: US 2025/0315498 A1
(43) Pub. Date: Oct. 9, 2025

(54) METHOD AND A SYSTEM FOR COMPUTER-IMPLEMENTED PROCESSING OF DATA SAMPLES USING AN N-POINT RADIX-P-FAST FOURIER TRANSFORM, FFT

(71) Applicant: Deutsches Zentrum für Luft- und Raumfahrt e. V., Bonn (DE)

(72) Inventor: Maron Schlemon, München (DE)

(21) Appl. No.: 19/095,160

(22) Filed: Mar. 31, 2025

(30) Foreign Application Priority Data
Apr. 4, 2024 (DE) 102024109476.1

(51) Int. Cl. G06F 17/14

(52) U.S. Cl. CPC G06F 17/142

(57) ABSTRACT

The present invention relates to a method for computer-implemented processing of data-samples using a N-point Radix-p-Fast Fourier Transform, FFT, with a total number of l transformation stages, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, the transformation of the last transformation stage l comprising the steps of:
a) sequential loading (LRS) of the vector registers of the penultimate transformation stage i−1 by a vectorized operation, and by adhering to a pre-calculated reordering index different from the natural order, or gathering loads and constructing pre-calculated vectors having a reordering index different from the natural order for the last transform stage l;
b) applying a Radix-p butterfly (ABS) to the arranged vector registers; and
c) storing the output (STLS) of the Radix-p butterfly, where the indices of the data values of the last transformation stage l are given in natural order.

### BACKGROUND

The present invention relates to a method and a system for computer-implemented processing of data samples using an N-point Radix-p-Fast Fourier Transform, FFT.

The Fast Fourier Transform (FFT) is a widely utilized algorithm that computes the discrete Fourier transform (DFT) of a sequence or its inverse (IDFT). It is a cornerstone in digital signal processing and finds extensive applications across various scientific, engineering, and technological domains. FFT may be used in the following different fields:

1. Signal Processing: FFT is pivotal in processing audio, video, and telecommunications signals. It allows for efficient signal filtering, analysis, and transformation, enabling various applications such as noise reduction, equalization, and compression.

2. Medical Imaging: In medical imaging technologies like MRI and CT scans, FFT helps reconstruct and enhance images. It is used to analyze frequency components within the image, improving both clarity and detail.

3. Aerospace and Radar Systems: FFT plays a vital role in synthetic aperture radar (SAR) technology and other radar systems. It aids in target detection, imaging, and tracking, enhancing the capabilities of modern defense and space exploration systems.

4. Weather Prediction: FFT provides essential insights into weather patterns and helps create accurate forecasts by analyzing meteorological data.

5. Financial Analysis: In the financial sector, FFT is an instrument for analyzing trends and patterns within various financial instruments, facilitating the creation of trading algorithms and risk management strategies.

6. Music and Audio Processing: FFT enables the analysis of audio signals for music production, including pitch correction, equalization, and spectral analysis. It is an essential tool for both professional audio engineers and hobbyists.

7. Scientific Research and Computational Chemistry: FFT assists in solving partial differential equations (PDEs) and analyzing complex datasets in research, including areas like quantum mechanics and molecular dynamics simulations.

8. Seismology: By analyzing seismic waves, FFT helps study Earth's interior and predict and analyze earthquakes.

9. Network Analysis: FFT analyzes network traffic, allowing for better management and security monitoring in modern communication systems.

10. Machine Learning and Data Analysis: FFT is also leveraged in machine learning for feature extraction and data preprocessing, enabling efficient training of models.

The widespread use of FFT is attributed to its efficiency. Traditional DFT computations require O(N²) operations. In contrast, FFT significantly reduces this complexity to O(N log(N)), making it a powerful tool in modern computational tasks (see reference [P1]). Ultimately, it allows for real-time processing and analysis across various applications. Its ongoing research and development continue to broaden its applicability, making FFT an essential element in the ever-expanding world of technology and science.

Numerous FFT algorithms (as described, for example, in references [P1, P2, P3, P4, P5, P6, P7]) have emerged in digital signal processing. Due to its popularity, the Cooley-Tukey algorithm (see [P7]) features most FFT libraries optimized for specific hardware architectures. Despite the effectiveness of conventional approaches, certain drawbacks limit the FFT's full optimization potential.

Traditional FFT implementations face challenges such as:
Reordering Stage Requirement: Many typical FFT algorithms require a reordering stage to rearrange data in a specific sequence. This extra step increases computational overhead and complicates the design and execution of the algorithm.
Incomplete Vectorization: Existing FFT methods often only partially achieve vectorization, particularly in the reordering stages. Scalar operations frequently occur in these stages, hindering full SIMD utilization and limiting optimization capabilities.
Implementation Complexity: Reordering and partial vectorization challenges lead to a more complex and error-prone implementation process. This complexity may hamper efficiency, especially when adapting the algorithm to various hardware environments.
Optimization Challenges: While various Radix-based FFT implementations exist, attaining optimal performance aligned with modern hardware still needs to be achieved. Traditional techniques often require intricate tuning and may fail to deliver the best possible performance. Radix algorithms commonly implement the FFT, breaking the transformation into subproblems based on a specific base or radix.

The radix approach is a widespread solution but must confront the challenge of reordering or bit-reversal, which can impose additional computational overhead and complexity. This includes challenges, such as:
In-Place Reordering and Computation Decoupling: Radix algorithms often allow in-place computation by reordering within the existing data structure. This in-place technique can eliminate the need for reordering later in the process by executing a bit-reversal algorithm to rearrange the elements initially. Moreover, specific radix algorithms can decouple computation from reordering, enabling computation in the natural order and integrating reordering within the computational steps.
Specialized Implementations and Mixed-Radix Algorithms: Some specialized radix algorithms minimize or eliminate reordering by structuring the computation to match the data's natural order. Though this may increase complexity in indexing or additional computation, it avoids the explicit reordering stage. Mixed-radix algorithms further alleviate the reordering challenge by employing different radixes, offering flexibility in the computational structure and reducing or removing the reordering requirement.
Hardware Capabilities and Vectorization: Utilizing modern hardware with vectorized instructions efficiently answers the reordering challenge. Hardware-based shuffling can be more proficient than software-based solutions, aligning with the innovative approach that fully vectorizes the FFT algorithm and eradicates the need for a separate reordering stage.

Radix-based FFTs, such as Radix-2, are underpinned by a divide-and-conquer methodology that yields significant computational efficiency. This strategy requires a continuous subdivision of the problem, systematically processing pairs of data points and larger groups until the entire dataset is covered. In the initial stages of the Radix-2 FFT, the algorithm pairs adjacent points together. In subsequent stages, the algorithm combines these pairs into larger groups, doubling in size with each step until it processes the entire data set. This division involves processing the least significant bits in the indices, leading to an outcome where the indices are arranged in a bit-reversed order (see [P1]). The bit-reversed ordering is not a mere artifact but a structural consequence of the efficient computational approach. While mathematically proficient, this order does not align with the original sequence, necessitating a reordering step.

The bit-reversed order in Radix-based FFTs directly results from the divide-and-conquer technique that grants these algorithms their efficiency. Handling this ordering varies between implementations, reflecting a broader consideration of efficiency, complexity, and the application's specific needs.

The above-described process is exemplified by Table 1, which shows the traits of a 4096-point Radix-4 FFT. In this example, systems with vector (SIMD) support ranging from 128-bit to 2048-bits or possibly wider is assumed. Table 1 demonstrates that the initial five stages (i=1 . . . 5) are conveniently vectorizable as their range surpasses the vector length for float16, float32, or float64 data format.

TABLE 1
4096-point Radix-4 FFT traits

| Stage i | Range | Vector (Registers) | Description |
|---|---|---|---|
| 1 | 1024 | 128-2048 bits | FFT |
| | | for F32 and F64 | transformation process |
| 2 | 256 | 128-2048 bits | |
| | | for F32 and F64 | |
| 3 | 64 | 128-2048 bits | |
| | | for F32 and F64 | |
| 4 | 16 | 128-512 bits for F32 | |
| | | 128-1024 bits for F64 | |
| 5 | 4 | 128 bits for F32 | |
| | | 128-256 bits for F64 | |
| 6 | 1 | — | |
| Reorder | — | — | Reordering process |
| (final stage) | | | |

In the last stage, i=6, no vectorization is possible. Thus, scalar operations are needed for further processing. Further, the “reordering process” cannot be processed with vectors using SIMD operations.

FIG. 1 shows the difficulties in vectorizing the final transformation step, in the present example above in stage 6, and the subsequent reordering stage of radix-based FFTs. They stem from these stages' inherent computational patterns and SIMD architecture's characteristics. In the last step of an FFT, operations must be executed on groups of data points that align with the FFT's radix (e.g., four adjacent elements for Radix-4 FFTs).

In FIG. 1A, the groups of data points are indicated by

$${v}_{1}^{Re} , {v}_{2}^{Re} , {v}_{3}^{Re} , {v}_{4}^{Re} and {v}_{1}^{Im} , {v}_{2}^{Im} , {v}_{3}^{Im} , {v}_{4}^{Im} ,$$

where the elements of each group are denoted with Re[n], . . . , lm[n] in the left-hand column Out2/In3, where n represents an index 0 . . . 7 of the data values. As shown in FIG. 1, the indices of the input In3 corresponding to output Out3 from the previous stage are in natural order (short: NO). However, SIMD operations are designed for maximum efficiency when dealing with contiguous data blocks. In FIG. 1A, the middle column denoted with RV-B and IV-B illustrates that no unified operation (set of same instructions) is possible as the mathematical operation applied to the loaded elements of a group is non-uniform for both real-valued butterfly RV-B and imaginary-valued butterfly IV-B operation. Additionally, after applying the butterfly operations, the elements are stored in the same groups or vectors in bit-reversed order (short: BRO), as can be seen from right-hand column Out3.

Given that these data groups (i.e., vector registers

$${v}_{1}^{Re} , {v}_{2}^{Re} , {v}_{3}^{Re} , {v}_{4}^{Re} )$$

are not typically laid out sequentially in memory, this misalignment poses a significant challenge to the straightforward application of SIMD. Moreover, the reordering stage, which uses the data of output Out3 as input and which entails rearranging data into bit-reversed order, presents its complexities. This succeeding stage involves a non-uniform operation, conflicting with the uniform nature of SIMD operations, which concurrently execute the same instruction across multiple data points. The reordering process requires knowledge about the position of each element of data, which fits differently than the SIMD model, where operations are carried out in parallel on multiple data points.

The object of the present invention is to provide an improved method and system for computer-implemented processing of data-samples using a N-point Radix-p Fast Fourier Transform, FFT, avoiding the problems described above.

These objects are solved by a method according to the features of the method claim 1, a computer program product according to the features of claim 10, and a system according to the features of claim 11. Preferred embodiments are set out in the independent claims.

### SUMMARY

According to a first alternative of a first aspect of the invention, a method for computer-implemented processing of data-samples using a N-point Radix-p Fast Fourier Transform, FFT, with a total number of l transformation stages is proposed. The output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width. Each register stores a vector of data values calculated by V_{size}/DT, where DT is the data type. Up to the penultimate transformation stage l−1, the transformation has been carried out in natural order. The transformation of the last transformation stage l comprises the steps of:
a) sequential loading of the vector registers of the penultimate transformation stage i−1 by a vectorized operation, and by adhering to a pre-calculated reordering index different from the natural order;
b) applying a Radix-p butterfly to the arranged vector registers; and
c) storing the output of the Radix-p butterfly, where the indices of the data values of the last transformation stage l are given in natural order.

According to a second alternative of the first aspect of the invention, a method for computer-implemented processing of data-samples using a N-point Radix-p Fast Fourier Transform, FFT, with a total number of l transformation stages is proposed. The output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width. Each register stores a vector of data values calculated by V_{size}/DT, where DT is the data type. Up to the penultimate transformation stage l−1, the transformation has been carried out in natural order. The transformation of the last transformation stage l comprises the steps of:
a) gathering loads and constructing pre-calculated, i.e. required, vectors having a reordering index different from the natural order for the last transform stage l;
b applying a Radix-p butterfly (ABS) to the arranged vector registers; and
c) storing the output (STLS) of the Radix-p butterfly, where the indices of the data values of the last transformation stage/are given in natural order.

The approach proposed offers a transformative solution that seamlessly integrates reordering within the vectorization of the last step of the FFT. By discarding the reordering stage and achieving full vectorization, this new FFT algorithm surpasses the limitations of existing methods, introducing a streamlined and efficient process adaptable to various applications.

In a further preferred embodiment of the first alternative, before applying the Radix-p butterfly, at least loaded two vector registers are combined to form wider vector registers for higher data throughputs. Before applying the Radix-p butterfly is to be understood that this step is performed between steps a) and b). More particularly, a transposition may be performed to arrange the vectors according to the transformation of the last stage l, thereby having a predetermined reordering index. In some embodiments, the transposition (PTS) may be a partial transposition. For example, a transposition or a partial transposition is performed on each of a first half of the combined vector registers and a second half of the combined vector registers in order to arrive at further combined vector registers of 2p data values having a predetermined reordering index.

In a further preferred embodiment of the second alternative, reordering indices may be processed as input for constructing index vectors in gather load instructions.

According to a further embodiment, the Radix-p-based FFT is a Radix-2-algorithm or a Radix-4-algorithm, i.e. p=2 or p=4.

According to a further embodiment, adhering to the pre-calculated reordering index comprises rearranging operations of the indices to achieve the natural order after having applied the Radix-p butterfly. In particular, the rearrangement operation comprises a rearrangement into blocks of uniform arithmetic operations enabling reuse of vector registers for each iteration. A further rearrangement may comprise reordering indices by using sequential or gather load instructions to load p vector registers at given indices. It may be advantageous that a p×p vectorized transpose is performed to build input information for step b).

According to a further embodiment, performing the partial transposition comprises transposing portions of the pre-arranged and combined vectors. E.g., in the case of 256-bit vectors and F32 data-type the partial transpose applies to the higher and lower 128 bits of the vector group.

According to a further embodiment, steps a) to c) are processed for each single iteration.

According to a second aspect, a computer program product comprising instructions which, when a computer executes the program, cause the computer to carry out the steps of the method of one or more preferred embodiments, is suggested.

According to a third aspect, a system for computer-implemented processing of data samples using a N-point Radix-p Fast Fourier Transform, FFT, with a total number of/transformation stages is suggested, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, where the system comprises a processor which is configured to perform one of the methods or one or more preferred embodiments thereof.

The approach outlined in this description, integrating reordering with vectorization, presents a solution to the challenge, aligning with the ongoing drive for optimization in FFT computation.

### BRIEF DESCRIPTION OF THE DRAWINGS

The invention will be described in detail by embodiments shown in the accompanying drawings.

FIG. 1A shows a diagram illustrating challenges in vectorizing the last stage and reordering phase of a FFT implementation;

FIG. 1B shows a the procedure of generating input vectors for the last FFT transformation stage, both for float32 and float64 data types;

FIG. 2 a flow chart for the last stage of radix based FFTs by generating input vectors for last transform stage using a Radix-4 based 64-point FFT AVX256-bit Float 32 as example;

FIG. 3 a table illustrating the last transform stage showing a bit-reversed output resulting from the penultimate transform stage;

FIG. 4 a table illustrating the last transform stage employing scalar optimization;

FIG. 5 a table illustrating the last transform stage employing a vectorization;

FIG. 6 a table illustrating the last transform stage employing a vectorization and sorting;

FIG. 7 an illustration showing sequential SIMD loads to enhance reading performance;

FIG. 8 an illustration showing 4×4 vectorized transpose to build required vectors for the last transformation stage;

FIG. 9 a table illustrating the first iteration of the last transform stage of a 64-point Radix-4 FFT being 256/512 bit vectorized;

FIG. 10 a table illustrating the second iteration of the last transform stage of a 64-point Radix-4 FFT being 256/512 bit vectorized;

FIG. 11 an illustration showing sequential SIMD loads to enhance reading performance for vectors 0 to 7;

FIG. 12 a diagram illustrating generation larger vectors for enhanced transformation performance and throughput;

FIG. 13 a table illustrating the last transform stage of a 64-point Radix-4 FFT being 512 bit vectorized for iteration 1;

FIG. 14 a table illustrating the last transform stage of a 64-point Radix-4 FFT being 512 bit vectorized for iteration 2;

FIG. 15 a flow chart for the last stage of radix based FFTs by generating input vectors for last transform stage using a Radix-4 based 64-point FFT-ARM SVE 256-bit Float 32 as example;

FIG. 16 a flow chart for the last stage of radix based FFTs by generating input vectors for last transform stage using a Radix-4 based 64-point FFT AVX128-bit Float 32 as example;

FIG. 17 a flow chart for the last stage of radix based FFTs by generating input vectors for last transform stage using a Radix-4 based 64-point FFT AVX256-bit Float 64 as example;

FIG. 18 a flow chart for the last stage of radix based FFTs by generating input vectors for last transform stage using a Radix-4 based 64-point FFT AVX512-bit Float 64 as example; and

FIG. 19 a flow chart for the last stage of radix based FFTs by generating input vectors for last transform stage using a Radix-4 based 64-point FFT-ARM NEON 128-bit Float32 as example.

### DETAILED DESCRIPTION

According to the present invention, the method is based on data samples processing using an N-point Radix-p Fast Fourier Transform, FFT, which is generally known to the skilled person. N-point Radix-p FFTs is based on SIMD operations to ensure efficient processing.

SIMD, an acronym for Single Instruction, Multiple Data, is a parallel processing architecture within a CPU that significantly enhances computational efficiency by executing the same operation on multiple data points simultaneously. This contrasts with scalar operations, which process a single data point per operation. SIMD's effectiveness is particularly evident in data-intensive tasks such as digital signal processing, multimedia applications, and scientific computations.

The key concepts of SIMD are:
SIMD Registers: Central to SIMD's capabilities are its registers, ranging from 128 bits to 2048 bits in advanced architectures. The size of these registers determines the amount of data that can be processed in parallel. For example, a 128-bit SIMD register can simultaneously handle four 32- or two 64-bit operations, while a 2048-bit register could manage sixteen 128-bit operations concurrently.
Efficiency over Scalar Operations: SIMD's parallel processing capability contrasts with scalar operations performed by traditional ALU (Arithmetic Logic Unit) components in CPUs. While ALUs handle one data element per instruction, SIMD can process multiple elements. This parallelism allows for significant speedups in tasks with repetitive and parallelizable operations, such as matrix multiplications or vector operations, by reducing the instruction cycle count. Resulting from these differences, SIMD and ALU units have distinct roles in a CPU. The ALU handles basic arithmetic and logical operations, typically on scalar values. In contrast, SIMD units are designed for ‘wide’ operations, exploiting data-level parallelism. This distinction makes SIMD units particularly effective for tasks with high data parallelism, whereas ALUs are more suited for general-purpose computations where such parallelism is absent.
Application-Specific Optimization: SIMD's effectiveness heavily depends on the nature of the task. Applications with repetitive and regular computations can use SIMD to achieve substantial performance gains. However, tasks with irregular data patterns or those requiring significant branching may not see similar benefits.

Up to now, the last stage of a N-point Radix-p FFTs cannot be processed using SIMD operations as no sequential loading of data elements and no unified operations are possible. The suggested method deals with these drawbacks.

Vectorizable loops are loops in programming that can be optimized through vectorization, a process in which operations within the loop are executed simultaneously on multiple data points using SIMD instructions. This technique improves computational efficiency, particularly in data-intensive tasks.

The key concepts of vectorizable loops are:
Uniform Operations: The loop performs the same operation on multiple independent data elements.
Data Independence: No iteration of the loop depends on the results of another, ensuring that parallel execution is feasible.
Regular Data Structures Efficient vectorization often requires storing data in regular contiguous memory blocks.

Vector-vector multiplication is a classic example of a vectorizable loop. Consider two arrays (vectors) A and B of the same size, where each element of the resultant array C is the product of the corresponding elements in A and B. In this case, each multiplication operation is independent of the others. The loop iterates over arrays A and B, multiplying each pair of elements. This independence makes it an ideal candidate for vectorization, where a SIMD processor can simultaneously compute multiple products, significantly speeding up the operation.

The Fast Fourier Transform (FFT) is a widely utilized algorithm that efficiently computes the discrete Fourier transform (DFT) of a sequence x(n). Calculating the DFT directly, the following formula are used:

$${X}^{F} ( k ) = {\sum }_{0}^{N - 1} x ( n ) {W}_{N}^{kn} n = 0 , 1 , 2 , … , N - 1 \qquad ( 1 )$$

$${W}_{N}^{kn} = exp ( - j 2 π \frac{kn}{N} ) = cos ( 2 π \frac{kn}{N} ) + j sin ( 2 π \frac{kn}{N} ) \qquad ( 2 )$$

Direct computation of an N-point DFT requires nearly O(N²) complex arithmetic operations. An arithmetic operation implies multiplication and addition. However, developing efficient algorithms, such as Radix-2 or Radix-4, can significantly reduce the complexity to process FFT. In general, fast algorithms reduce the computational complexity of an N-point DFT to about N log₂ (N) complex arithmetic operations. Additional advantages are reduced storage requirements and computational error due to finite bit-length arithmetic (multiplication/division and addition/subtraction, to be practical, are implemented with finite word lengths). Fast algorithms have contributed to the DFT implementation by DSP chips. FFT algorithms can be implemented in several ways, with the decimation-in-time (DIT) 1 and decimation-in-frequency (DIF) 2 methods being the most common for the Radix-2 and Radix-4 algorithms. Both methods yield the same result but differ in their approach to decomposing and processing the sequence.

The Radix-2 Decimation-In-Frequency (DIF) Fast Fourier Transform (FFT) is an efficient algorithm to compute the discrete Fourier Transform (DFT) of a sequence. It is particularly suited for sequences whose length is a power of two. The key characteristics of the Radix-2 DIF FFT can be outlined as follows:
Frequency Decimation: The algorithm decomposes the original DFT problem (size) by systematically breaking down the frequency spectrum. Initially, it separates the full spectrum into two halves, representing the lower and upper halves of the frequency range. This process repeats recursively, dividing the spectrum into smaller frequency bins.
Butterfly Operations: At each stage of decomposition, the Radix-2 DIF FFT algorithm employs a computational element known as a “butterfly” operation. These operations involve basic arithmetic calculations, such as additions, subtractions, and multiplications by complex twiddle factors

$${W}_{N}^{kn} .$$

The twiddle factors are complex exponential functions fundamental to the Fourier transform.
In-Place Computation: The algorithm reuses the same memory space for input and output data, significantly reducing memory requirements. It uses small local computation buffers for efficiency and intermediate storage.

The number of transform stages of a Radix-2 FFT can be determined by 2^{l}=N→l stages. The complex-valued Radix-2 butterfly is given in equations (3) and (4).

$${x}_{{S}_{i}} ( n ) = {x}_{Si - 1} ( n ) + {x}_{Si - 1} ( n + \frac{N}{2} ) \qquad ( 3 )$$

$${x}_{{S}_{i}} ( n + \frac{N}{2} ) = ( {x}_{Si - 1} ( n ) - {x}_{Si - 1} ( n + \frac{N}{2} ) ) {W}_{N}^{kn} for n = 0 , 1 , 2 , … , {N}_{i} - 1 . \qquad ( 4 )$$

x_{Si}(n) represents the transform of stage i for i=1, 2, . . . , l. x_{So}(n) are the complex input samples, given by:

$$x ( n ) = re ( n ) + j im ( n ) \qquad ( 5 )$$

Nᵢ is the range of stage i. Equation (5) represents the complex natural format in which the real and imaginary components are stored sequentially as pairs in memory. Analogously, the invention applies to the split-complex format where real and imaginary parts are stored sequentially in separate memory spaces.

As explained, Radix FFT algorithms are underpinned by a divide-and-conquer methodology that yields significant computational efficiency. This strategy requires a continuous subdivision of the problem, systematically processing pairs of data points and larger groups until the entire dataset is covered.

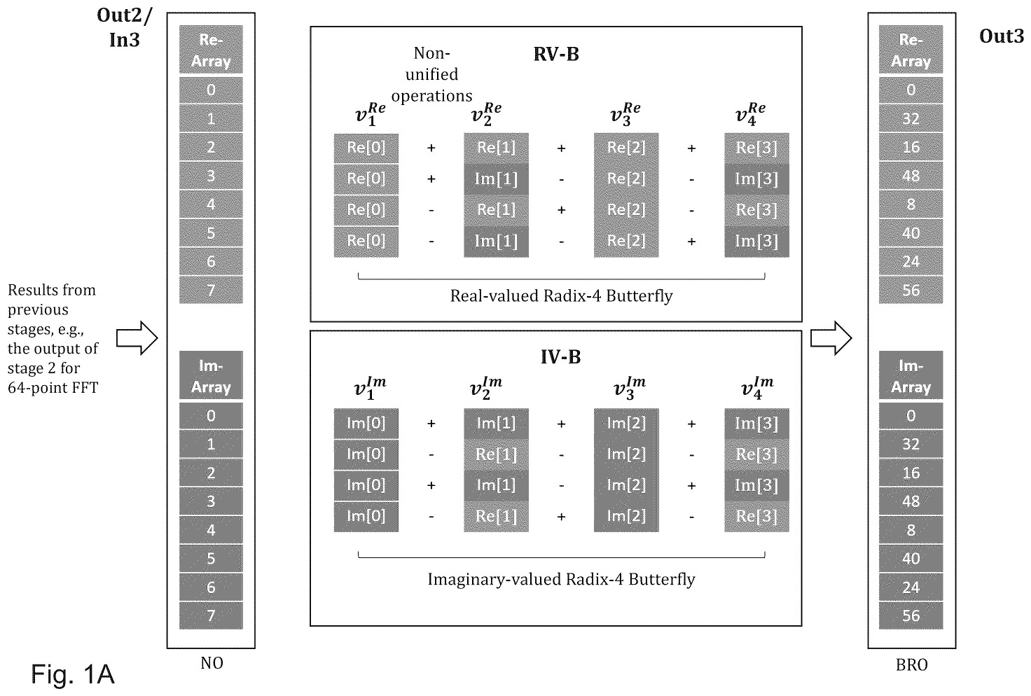

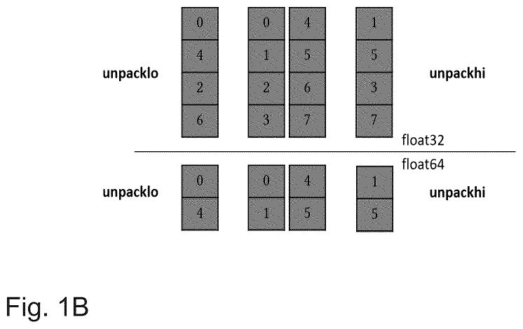

In the initial stages of the Radix-2 FFT, the algorithm pairs adjacent points together. In subsequent stages, the algorithm combines these pairs into larger groups, doubling in size with each step until it processes the entire data set. This division involves processing the least significant bits in the indices, leading to an outcome in which the indices are arranged in a bit-reversed order (see FIG. 1). The bit-reversed ordering is not a mere artifact, but a structural consequence of the efficient computational approach. While mathematically proficient, this order does not align with the original sequence, necessitating a reordering step.

Various strategies exist to manage the bit-reversed ordering challenge within Radix-based FFTs. Some algorithms weave this reordering into the computation, processing it as part of the algorithm's normal flow. Others designate it as a discrete step at the end of the transformation process.

The solution described below vectorizes the final transformation stage of the FFT algorithm and simultaneously integrates the reordering stage, thereby eliminating the need for a separate reordering process. This approach is explained in detail concerning Table 2, where NO represents the natural order, and BRO stands for the bit-reversed order. X[s] with s=1 . . . 7 represents data values, where s is the index of the data values of the input (left column).

TABLE 2
Last transform stage - bit-reversed output

| NO | Butterfly Operations | BRO |
|---|---|---|
| 0 | x[0] + x[1] | 0 |
| 1 | x[0] − x[1] | 4 |
| 2 | x[2] + x[3] | 2 |
| 3 | x[2] − x[3] | 6 |
| 4 | x[4] + x[5] | 1 |
| 5 | x[4] − x[5] | 5 |
| 6 | x[6] + x[7] | 3 |
| 7 | x[6] − x[7] | 7 |

Specifically, for an 8-point FFT, the input is taken in BRO, which results in an output in the natural order NO. Additionally, this method aligns arithmetic operations into unified groups of four, as depicted in Table 3. This alignment facilitates the implementation of vectorized additions and subtractions. A notable enhancement in this method is the requirement of only two vectors to complete the last transform and reordering stages in a single step. This optimization significantly increases data throughput and FLOPS. However, one challenge remains: the inability to use efficient sequential vectorized load instructions to construct the input vectors, as gather-operations are comparatively slow and thus undesirable on x86 and ARM Neon systems. On SVE gather loads are efficient and can replace the transpose functions. To address this, a solution that rearranges the data appropriately after two sequential loads is suggested. This procedure is exemplary detailed in FIG. 1B and relies only on fast unpack operations.

TABLE 3
Last transform stage - natural order

| BRO | Butterfly Operations | NO |
|---|---|---|
| 0 | x[0] + x[1] | 0 |
| 4 | x[4] + x[5] | 1 |
| 2 | x[2] + x[3] | 2 |
| 6 | x[6] + x[7] | 3 |
| 1 | x[0] − x[1] | 4 |
| 3 | x[2] − x[3] | 6 |
| 5 | x[4] − x[5] | 5 |
| 7 | x[6] − x[7] | 7 |

Table 3 shows that this strategic data rearrangement allows the continued use of efficient loading methods while achieving the desired vectorization and reordering in the final FFT transformation stage.

Like the Radix-2 approach, the Radix-4 DIF FFT algorithm offers an effective method for computing the DFT. This algorithm is especially well-suited for processing sequences whose lengths are powers of four. A crucial distinction of the Radix-4 algorithm lies in its butterfly operations: At each stage of the decomposition process, the butterfly operations encompass basic arithmetic calculations, as detailed in equation (6):

$$[ \begin{matrix}{x}_{{S}_{i}} ( n ) \\ {x}_{{S}_{i}} ( n + \frac{N}{4} ) \\ {x}_{{S}_{i}} ( n + \frac{N}{2} ) \\ {x}_{{S}_{i}} ( n + \frac{3 N}{4} )\end{matrix} ] = [ \begin{matrix}1 & 1 & 1 & 1 \\ {W}_{N}^{n} ( 1 & - j & - 1 & j ) \\ {W}_{N}^{2 n} ( 1 & - 1 & 1 & - 1 ) \\ {W}_{N}^{3 n} ( 1 & j & - 1 & - j )\end{matrix} ] [ \begin{matrix}{x}_{{S}_{i - 1}} ( n ) \\ {x}_{{S}_{i - 1}} ( n + \frac{N}{4} ) \\ {x}_{{S}_{i - 1}} ( n + \frac{N}{2} ) \\ {x}_{{S}_{i - 1}} ( n + \frac{3 N}{4} )\end{matrix} ] \qquad ( 6 )$$

These butterfly operations in Radix-4 are more complex than those in Radix-2 due to the involvement of more data by the reduced number of stages required for the decomposition, as Radix-4 processes four data points simultaneously compared to Radix-2's two. This characteristic makes Radix-4 inherently more efficient for sequences of appropriate lengths (powers of four), as it can achieve the same transformation with fewer overall operations. The efficiency of Radix-4 FFT thus emerges from this strategic combination of advanced butterfly operations and a reduced number of decomposition stages. The number of transform stages of a Radix-4 FFT can be determined by 4^{l}=N→l stages.

The procedure described pertains to the Radix-4 FFT algorithm. In the context of a 16-point Radix-4 FFT, the output is initially in bit-reversed order (BRO), mirroring the situation encountered with the Radix-2 FFT, where a reordering step is necessary to achieve the natural order of the output. This similarity in the output format between Radix-2 and Radix-4 FFTs requires additional focus on the reordering process to ensure efficient data handling and output presentation.

To dive deeper into the mechanics of this new reordering process, it is instructive to examine the last transform stage of a 64-point FFT. The 64-point FFT is just an illustrative example that offers a more complex scenario and highlights the challenges and solutions inherent in managing larger data sets. By exploring this stage, one can better understand how the reordering process is adapted and optimized in a larger FFT, such as the 64-point FFT, compared to the more straightforward 16-point FFT case.

The reordering process in the final stage of the 64-point FFT is critical for aligning the output in a naturally ordered sequence. This step is essential for ensuring that the FFT's output is presented in a format consistent with conventional data processing and analysis requirements. By focusing on this stage, we gain insights into the practical application of the reordering process and its impact on the overall efficiency and effectiveness of the FFT algorithm, particularly in more complex and data-intensive scenarios.

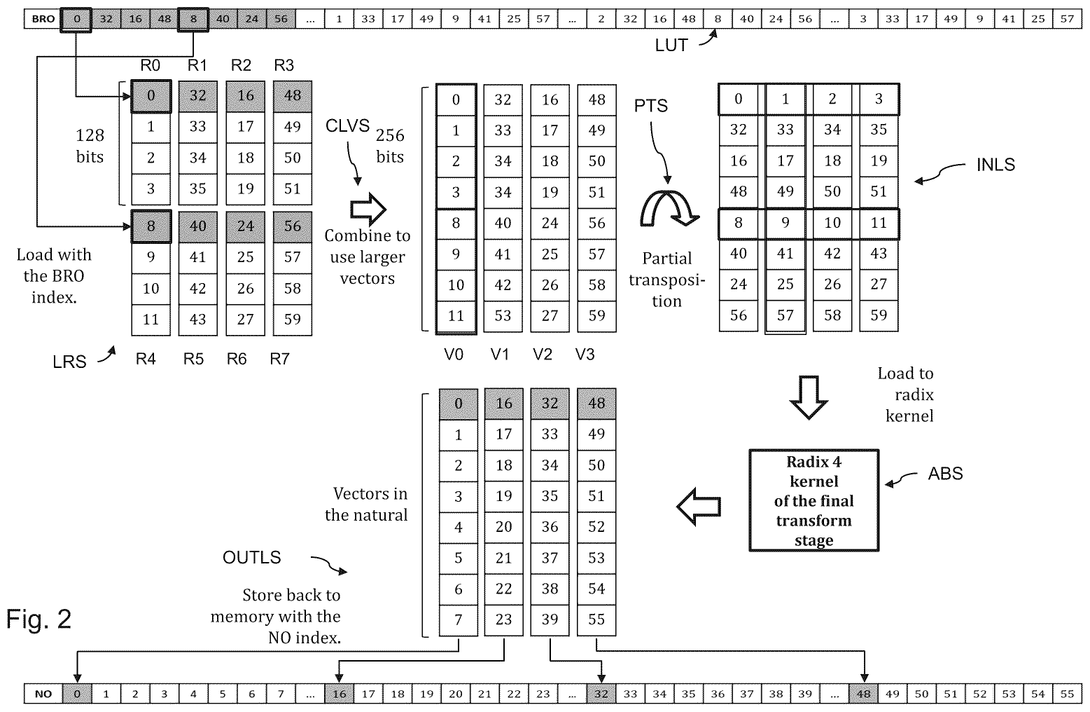

FIG. 2 demonstrates the basic steps of the suggested procedure within a 64-point FFT context for processing the last transformation stage of float32-based complex-valued data. The suggested approach in FIG. 2 takes advantage of eight 128-bit registers R0, . . . , R7. The BRO look-up table (LUT) is used to load the necessary vectors, shown at LRS, for the transform. The highlighted cell of each register (R0, . . . , R7) represents the base index for the load instructions. This loading scheme differs from the natural order. The next step CLVS is a pairwise combine of vectors R0 with R4 to V0, R1 with R5 to V1, R2 with R6 to V2, and R3 with R7 to V3 to generate larger vector for higher data throughput and FLOPS in the butterfly kernel (denoted with INLS). Subsequently, the partial transpose PTS is executed on the halves of the generated structure, which is then shifted to Radix butterfly (ABS). Finally, the data is stored sequently back to memory (see OULTS) in NO using the provided store indices (highlighted cells in first row). This efficient output handling ensures the entire process is streamlined and avoids unnecessary memory operations.

In the described case (float32 data and 256-bit vectors) of 64-points FFTs, in total, two iterations are needed to complete the operation, where FIG. 2 shows one of these iterations.

The present solution effectively eliminates the need for a reordering stage and simultaneously vectorizing the last step. This method leads to an entirely vectorized FFT algorithm, discarding scalar overhead and realizing optimal SIMD utilization rates.

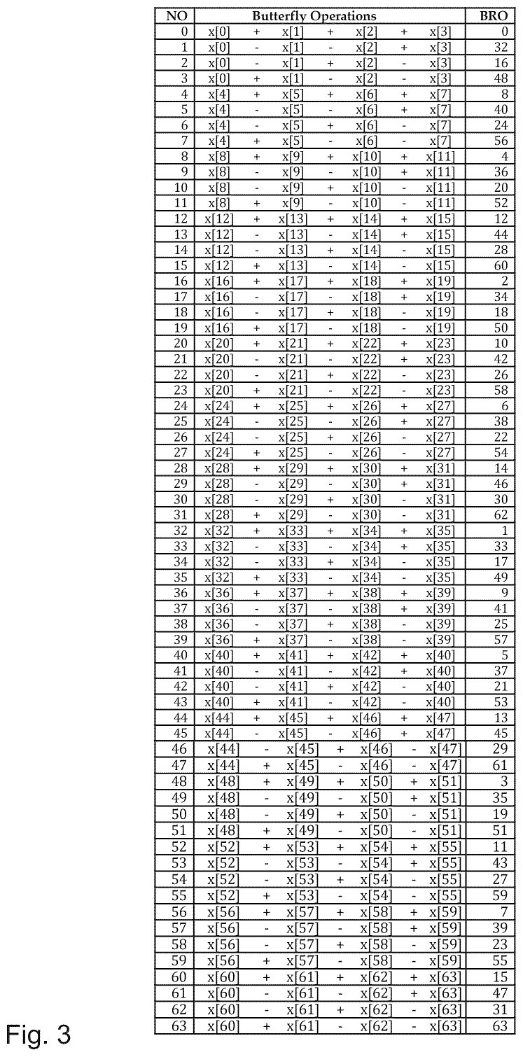

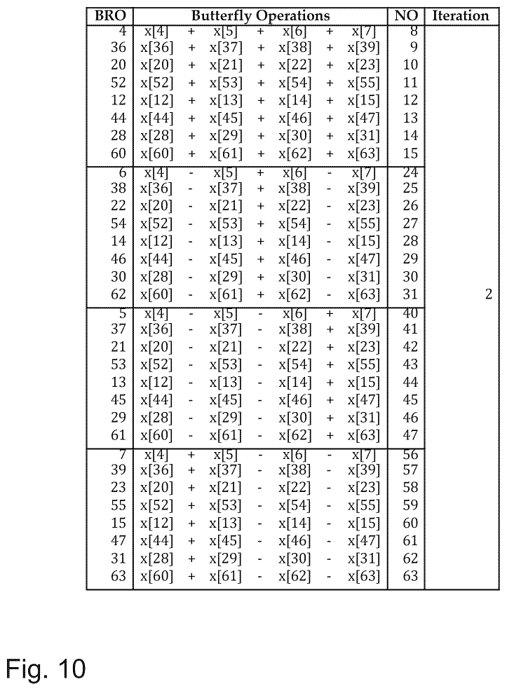

In more detail, the process for providing the pre-calculated indices which are loaded in step LRS of FIG. 2 is accomplished through a series of specific operations which is described by reference to FIGS. 3 to 14. The starting point for this procedure is the penultimate transformation stage i=l−1.

The output of the penultimate transformation stage l−1 is in bit-reversed order BRO, hindering the vectorization of the final transform stage. This limitation arises because butterfly operations, essential for this stage, require adjacent sample processing, which deviates from conventional SIMD capabilities, leading to inefficiency. Additionally, the non-uniformity of arithmetic operations, e.g., +−−+, complicates the implementation of SIMD instructions like vectorized add or subtract, rendering them unfeasible or necessitating significant overhead. The first optimization involves rearranging operations to achieve a natural order. The result is shown in the table in FIG. 3

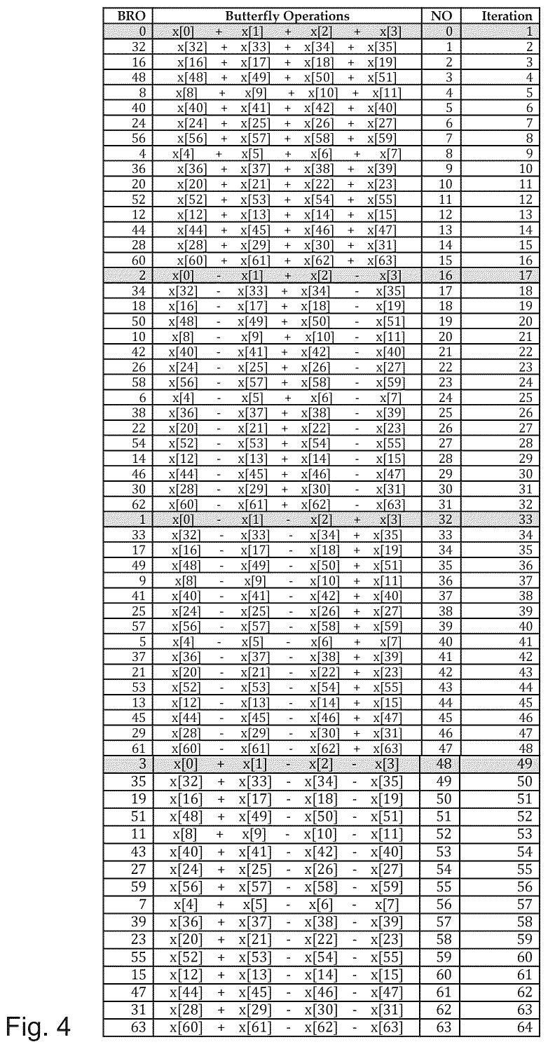

The modified process shown in FIG. 4 yields results in natural order NO. However, it introduces inefficiencies due to redundant load instructions (as indicated by the lines at BRO=0, 2, 1, 3) and the reliance solely on scalar operations for butterfly computations. This approach requires 64 iterations to complete the task (see last column). The following optimization strategy involves rearranging and amalgamating similar iterations to improve efficiency. This consolidation aims to reduce the total number of iterations and minimize redundancy, thereby improving computational efficiency.

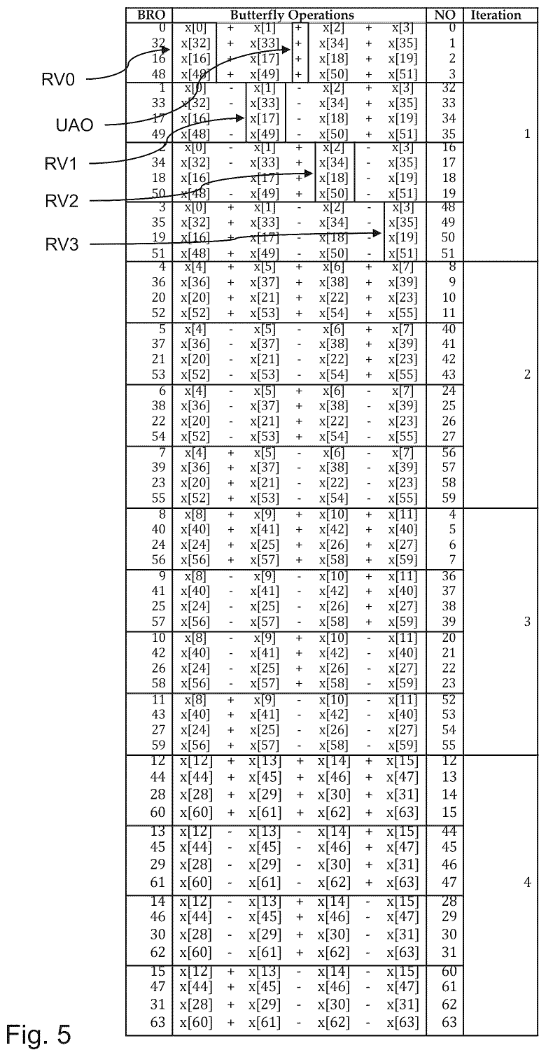

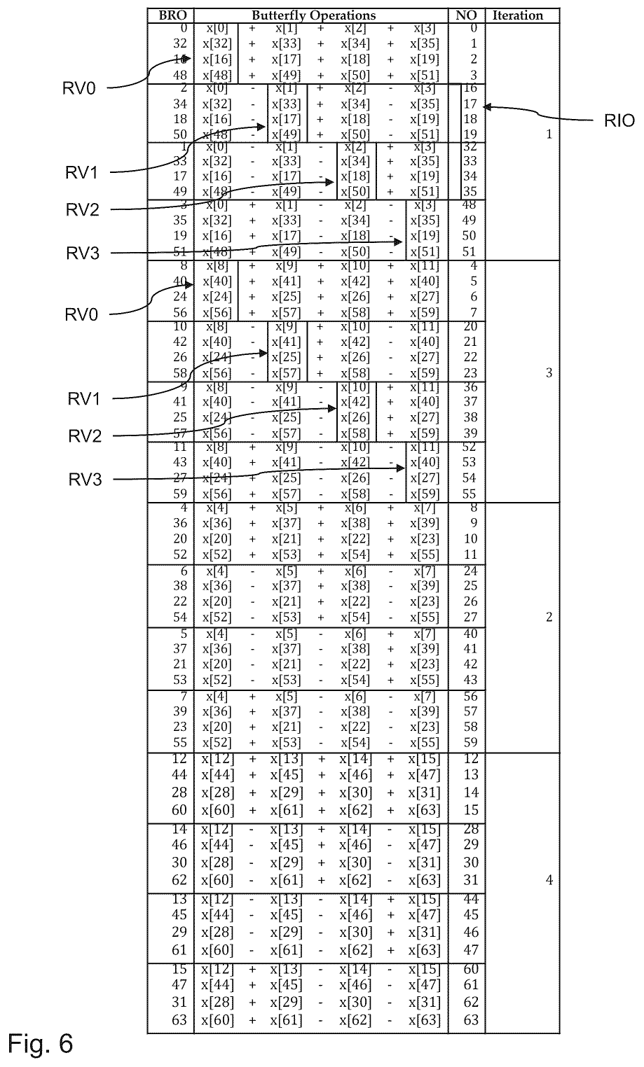

This approach significantly improves the transformation and reordering processes by utilizing 128-bit vectors, a development made feasible by the rearrangement into blocks of uniform arithmetic operations (indicated by block UAO in FIG. 5). In addition, each iteration efficiently reuses vectors multiple times, optimizing data handling (highlighted by RV0, RV1, RV2, RV3). This leads to a substantial reduction in the total number of iterations, now only four. In the subsequent phase, the focus shifts to further enhancing the write-out performance. This is achieved by rearranging the structure again, a strategic move designed to streamline the data-output process and maximize overall computational efficiency. The result is shown in FIG. 6 (indicated by block RIO).

To generate input vectors, reordering indices from the look-up table are employed, prioritizing optimal efficiency (FIG. 6). This is achieved by using sequential load instructions while deliberately avoiding gather instructions due to their relative inefficiency.

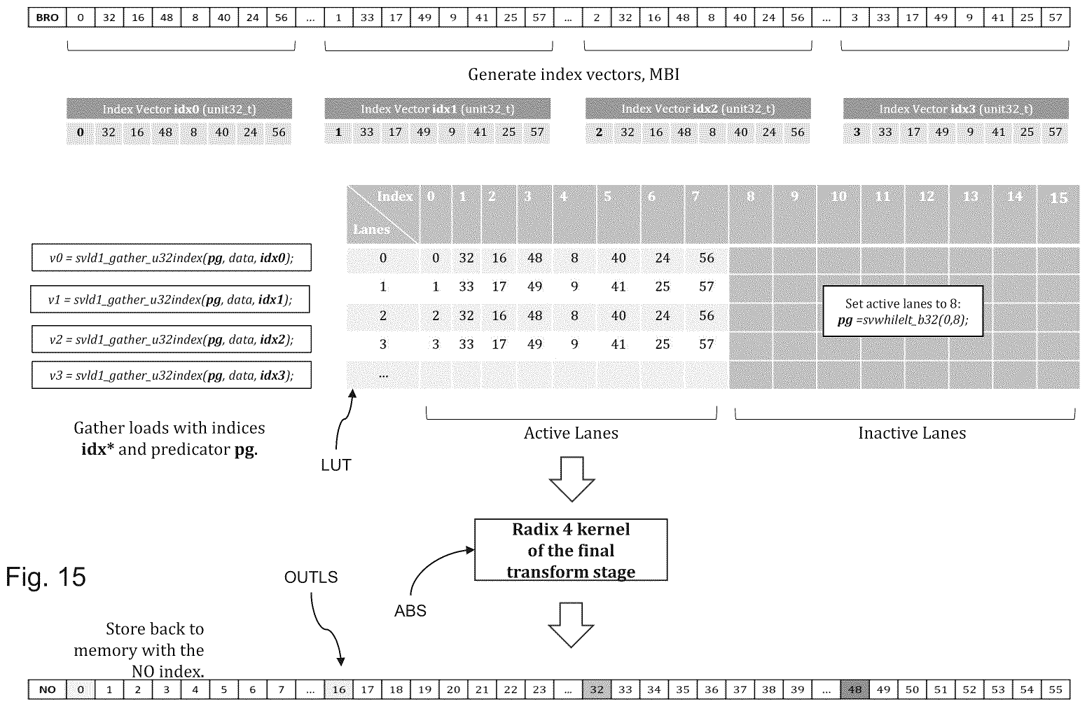

However, some systems may handle gather instruction efficiently. In such scenarios, the index vectors used to load the vectors are built by mapping BRO indices. Thus, the required data structure for the last transform stage is generated. FIG. 15 shows an example for ARM SVE systems. The first step consists of mapping the BRO indices from the look-up table, see BMI. A predicator pg sets the lane or vector width. In the given example, the vector length is set to 256 bits. Now, vectors v0, v1, v2, and v3 are generated using the predicators pg, the input data, and the pre-built index vectors from the BRO look-up table LUT. The four vectors are shifted to the Radix kernel (ABS) and then stored in memory (OUTLS) in the same form as described before.

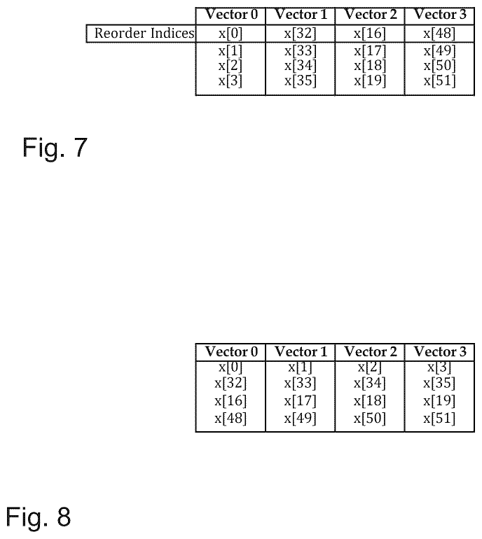

As illustrated in FIG. 7, we load four vectors at indices 0, 32, 16, and 48. Subsequently, a 4×4 vectorized transpose is performed (FIG. 8). This step is crucial because it constructs the vectors for the final transformation stage, ensuring streamlined processing and enhancing overall computational effectiveness.

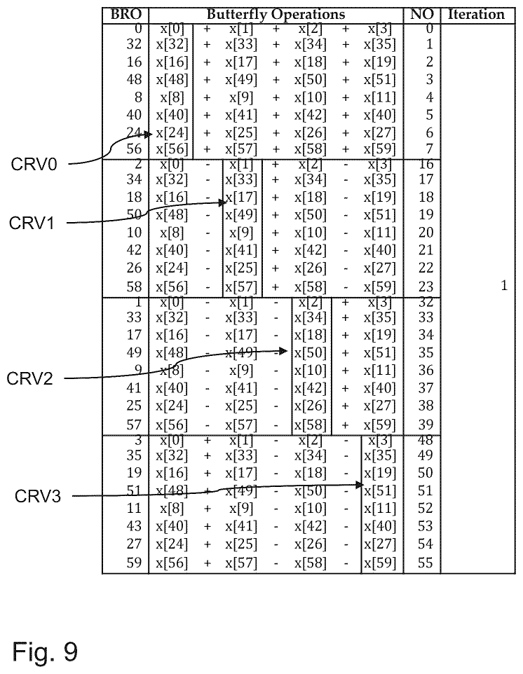

Assuming the float32 data type, performance can be further enhanced by merging 128-bit vectors to create larger 256-bit vectors. This approach uses the ability to efficiently handle more data in a single operation. As highlighted in the boxes CRV0, CRV1, CRV2, CRV3, the vectors x[0]x[0] and x[8]x[8] can be combined to form a single 256-bit vector (the combined vector of FIG. 2). The efficiency gains from this method, including reduced iteration counts and enhanced data throughput, are illustrated in the results presented in FIGS. 9 (for iteration 1) and 10 (for iteration 2). These tables demonstrate the improved data processing efficiency of this vector combination strategy.

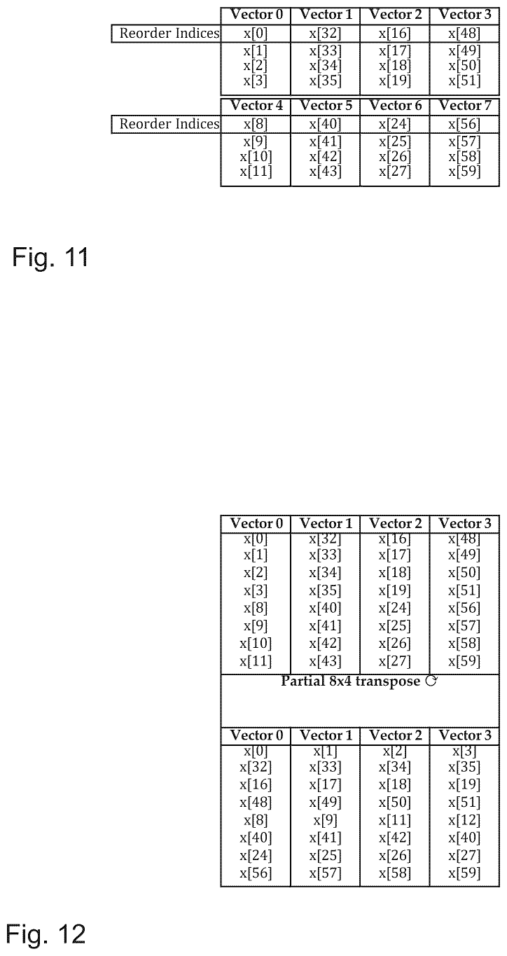

The merge or combination process described in FIGS. 8 to 10 involves sequentially loading eight 128-bit vectors for float32 (f32) data types or eight 256-bit vectors for float64 (f64) data types using the specified indices (FIG. 11). These vectors are then combined into larger ones, resulting in 256-bit vectors for f32 or 512-bit vectors for f64.

A partial transpose generates the necessary vectors, as the boxes denoted with CRV0, CRV1, CRV2, CRV3 in FIG. 9 indicate. Combining and transposing vectors significantly enhances performance, leading to a notable reduction in the required iterations, now only two. This streamlined approach optimizes processing efficiency by effectively managing data types and vector sizes.

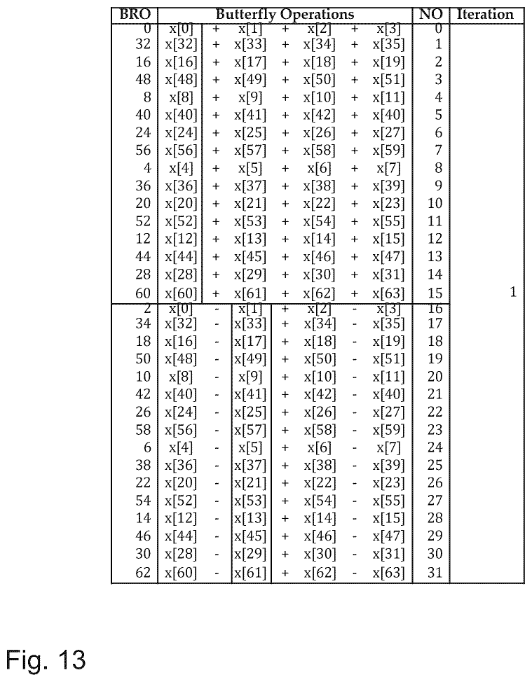

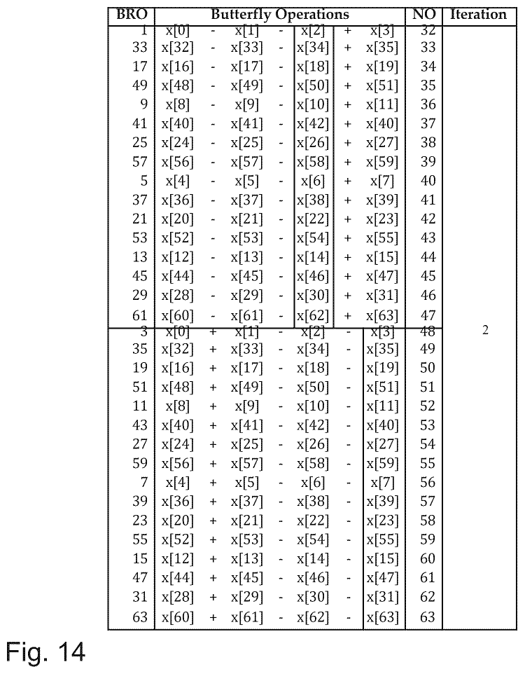

Similarly, we can optimize the performance using even larger registers, as FIGS. 13 and 14 show. This approach only needs a single iteration and provides the best performance. The four vectors can be generated by four partial transposes.

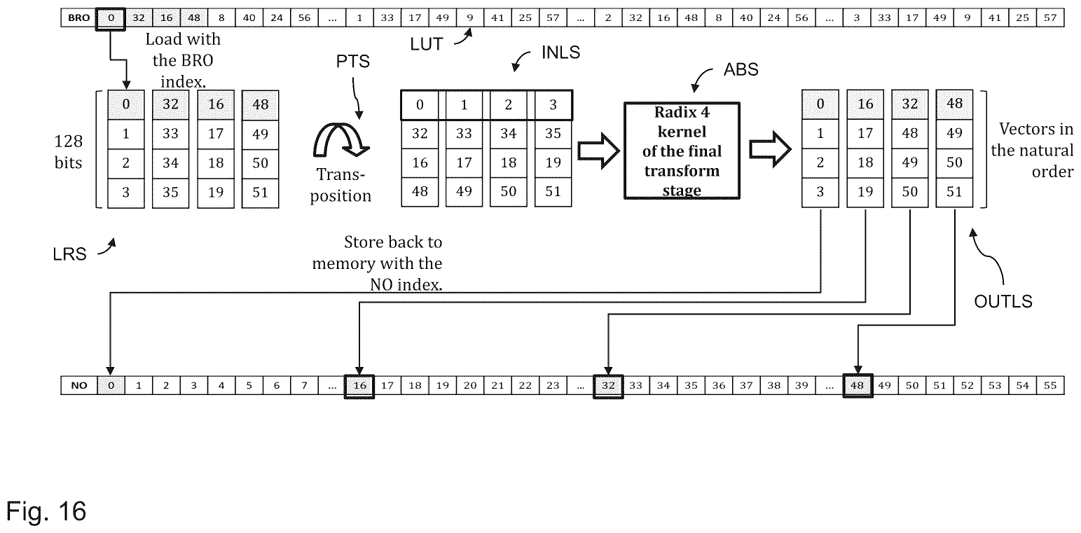

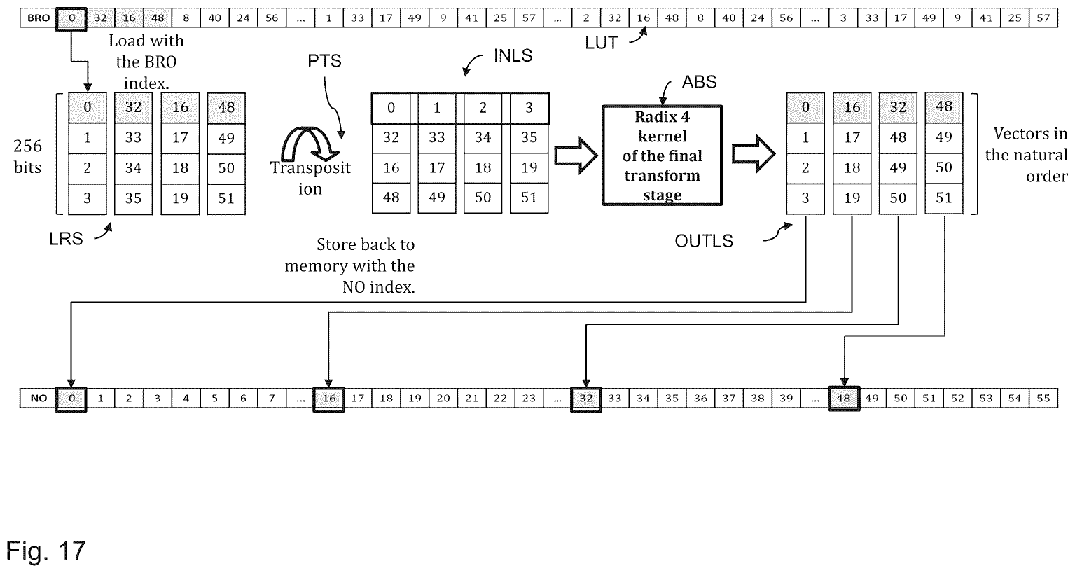

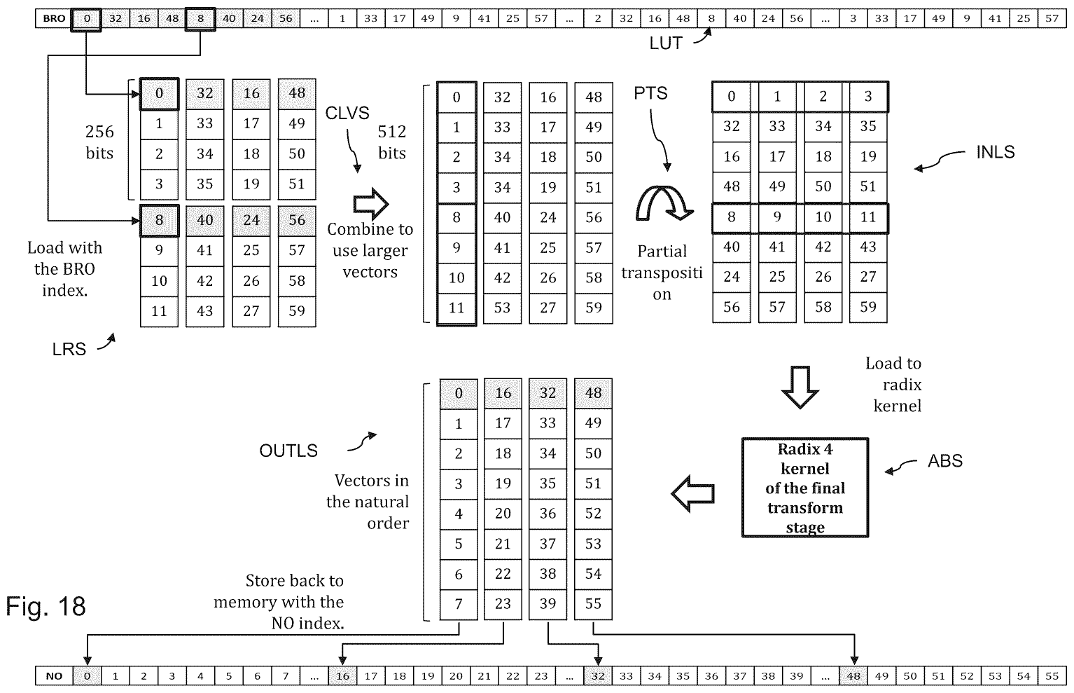

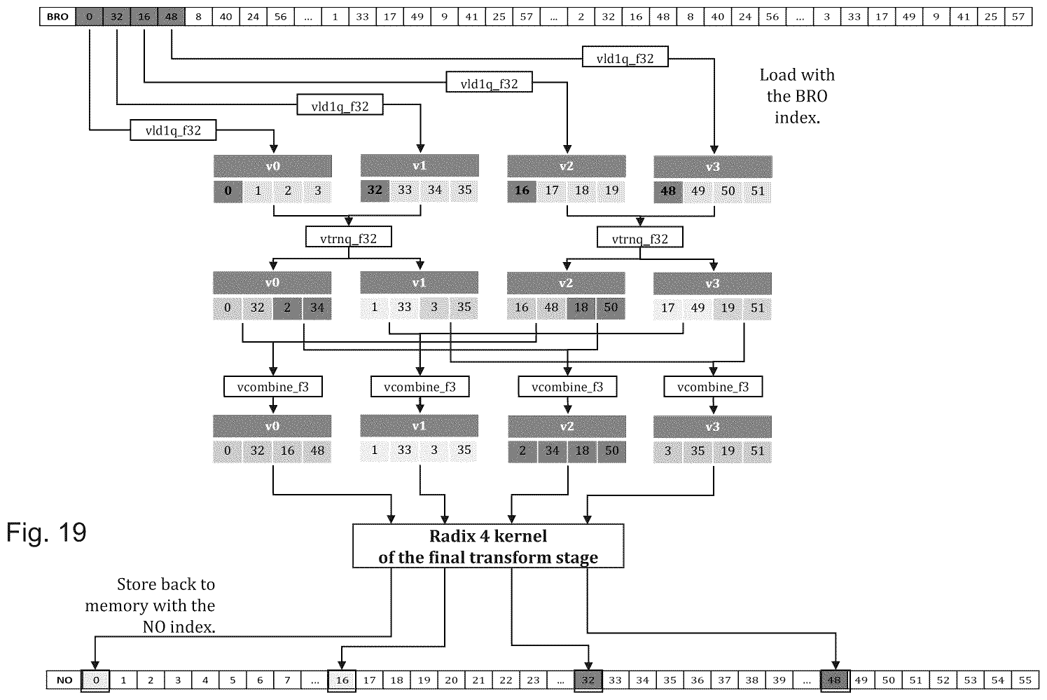

FIGS. 16 to 18 show further examples for AVX128-Bit Float 32, AVX256-Bit Float 64 and AVX512-bit Float 64. FIG. 19 shows a further example for 64-point FFT-ARM SVE 256-bit illustrating the procedures as described above.

As described, the method according to the invention vectorizes the last FFT transformation stage and eliminates the reordering stage by integrating it directly into it. This approach simplifies the overall process and makes it more efficient. By addressing the challenges typically associated with the last and reordering stages of the FFT, an algorithm can be implemented that is fully vectorized and optimized for modern hardware. Such advancements can significantly impact various real-time applications and open new avenues for research and development in the field.

The inventors have employed diverse hardware configurations comprising ground-based servers to evaluate the implementation. The evaluation involved single and double-precision one-dimensional complex transforms. Double-precision FFTs allow for more accurate computations at the expense of computational speed and memory.

Through these evaluations, it becomes clear that the suggested FFT implementation offers an effective and efficient alternative to existing FFT libraries. The generic code design enabled efficient testing across x86 and ARM platforms, demonstrating flexibility and potential for broader applications.

### REFERENCES

[P1] K. R. Rao, D. N. Kim, and J.-J. Hwang. 2011. Fast Fourier Transform—Algorithms and Applications. Springer Science+Business Media B.V, Dordrecht. https://doi.org/10.1007/978-1-4020-6629-0
[P2] L. Bluestein. 1970. A linear filtering approach to the computation of discrete Fourier transform. IEEE Transactions on Audio and Electroacoustics 18, 4 (1970), 451-455. https://doi.org/10.1109/TAU. 1970.1162132
[P3] P. Duhamel and Henk Hollmann. 1984. ‘Split radix’ FFT algorithm. Electronics Letters 20 (02 1984), 14-16. https://doi.org/10.1049/el: 19840012
[P4] D. Kolba and T. Parks. 1977. A prime factor FFT algorithm using high-speed convolution. IEEE Transactions on Acoustics, Speech, and Signal Processing 25, 4 (1977), 281-294. https://doi.org/10.1109/TASSP.1977.1162973
[P5] Zhihao Li, Haipeng Jia, Yunquan Zhang, Tun Chen, Liang Yuan, Luning Cao, and Xiao Wang. 2019. AutoFFT: A Template-Based FFT Codes Auto-Generation Framework for ARM and X86 CPUs. In Proceedings of the International Conference for High Performance Computing, Networking, Storage and Analysis (Denver, Colorado) (SC '19). Association for Computing Machinery, New York, NY, USA, Article 25,15 pages. https://doi.org/10.1145/3295500.3356138
[P6] Zhuo Qian and Martin Margala. 2016. Low-Power Split-Radix FFT Processors Using Radix-2 Butterfly Units. IEEE Transactions on Very Large Scale Integration (VLSI) Systems 24, 9 (2016), 3008-3012. https://doi.org/10.1109/TVLSI.2016.2544838
[P7] Sergio Vázquez, Margarita Amor, and Basilio B. Fraguela. 2019. Portable and efficient FFT and DCT algorithms with the Heterogeneous Butterfly Processing Library. J. Parallel and Distrib. Comput. 125 (2019), 135-146. https://doi.org/10.1016/j.jpdc.2018.11.011

1. A method for computer-implemented processing of data-samples using a N-point Radix-p-Fast Fourier Transform, FFT, with a total number of l transformation stages, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, the transformation of the last transformation stage l comprising the steps of:
a) sequential loading (LRS) of the vector registers of the penultimate transformation stage i−1 by a vectorized operation, and by adhering to a pre-calculated reordering index different from the natural order;
b) applying a Radix-p butterfly (ABS) to the arranged vector registers; and
c) storing the output (STLS) of the Radix-p butterfly, where the indices of the data values of the last transformation stage l are given in natural order.

2. A method for computer-implemented processing of data-samples using a N-point Radix-p-Fast Fourier Transform, FFT, with a total number of l transformation stages, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, the transformation of the last transformation stage l comprising the steps of:
a) gathering loads and constructing pre-calculated vectors having a reordering index different from the natural order for the last transform stage l;
b applying a Radix-p butterfly (ABS) to the arranged vector registers; and
c) storing the output (STLS) of the Radix-p butterfly, where the indices of the data values of the last transformation stage l are given in natural order.

3. The method according to claim 1, wherein, before applying the Radix-p butterfly (ABS), at least loaded two vector registers are combined (CLVS) to form wider vector registers for higher data throughputs.

4. The method according to claim 3, wherein a transposition (PTS) is performed to arrange the vectors according to the transformation of the last stage l, thereby having a predetermined reordering index.

5. The method according to claim 4, wherein the transposition (PTS) is a partial transposition.

6. The method according to claim 2, wherein reordering indices are processed as input for constructing index vectors in gather load instructions.

7. The method according to claim 1, wherein the Radix-p-based FFT is a Radix-2-algorithm or a Radix-4-algorithm.

8. The method according to claim 1, wherein steps a) to c) are processed for each single iteration.

9. The method according to claim 1, wherein adhering to the pre-calculated reordering index comprises rearranging operations of the indices to achieve the natural order after having applied the Radix-p butterfly.

10. The method according to claim 9, wherein the rearrangement operation comprises a rearrangement into blocks of uniform arithmetic operations enabling reuse of vector registers for each iteration.

11. The method according to claim 9, wherein a further rearrangement comprises reordering indices by using sequential load or gather load instructions to load p vector registers at given indices.

12. The method according to claim 9 in combination with claim 3, wherein a p×p vectorized transpose is performed to build input information for step b).

13. The method according to claim 9 in combination with claim 3, wherein performing the partial transposition comprises transposing portions of the pre-arranged and combined vectors.

14. The method according to claim 13, wherein interleaving data values is iterated, where the number of iterations depends on the number N of N-points and the radix p.

15. A Computer program product comprising instructions which, when the program is executed by a computer, cause the computer to carry out the steps of the method of claim 1.

16. A system for computer-implemented processing of data-samples using a N-point Radix-p-Fast Fourier Transform, FFT, with a total number of l transformation stages, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, where the system comprises a processor which is configured to perform the following steps in order to execute the transformation of the last transformation stage l:
a) sequential loading (LRS) of the vector registers of the penultimate transformation stage i−1 by a vectorized operation, and by adhering to a pre-calculated reordering index different from the natural order;
b) applying a Radix-p butterfly (ABS) to the arranged vector registers; and
c) storing the output (STLS) of the Radix-p butterfly, where the indices of the data values of the last transformation stage l are given in natural order.

17. A system for computer-implemented processing of data-samples using a N-point Radix-p-Fast Fourier Transform, FFT, with a total number of l transformation stages, where the output of each transformation stage i, with i=1 . . . ,l, and a range Rᵢ, where Rᵢ=Rᵢ₋₁/p with R₀=N, have been calculated in p-groups and Rᵢ/V_{size} vector iterations with V_{size} being the vector width, and where each register stores a vector of data values calculated by V_{size}/DT, where DT is the data type, and where up to the penultimate transformation stage l−1, the transformation has been carried out in natural order, where the system comprises a processor which is configured to perform the following steps in order to execute the transformation of the last transformation stage l:
a) gathering loads and constructing pre-calculated vectors having a reordering index different from the natural order for the last transform stage l;
b applying a Radix-p butterfly (ABS) to the arranged vector registers; and
c) storing the output (STLS) of the Radix-p butterfly, where the indices of the data values of the last transformation stage l are given in natural order.

18. The system according to claim 16, wherein the processor is configured to perform a method according to claim 2.

19. The system according to claim 17, wherein the processor is configured to perform a method according to claim 2.
